(19) United States
(12) Patent Application Publication
(10) Pub. No.: US 2013/0104331 A1
(43) Pub. Date: May 2, 2013

(54) Grill Grate Cleaning Tool

(71) Applicant: Michael T. Leis, Santa Clara, CA (US)

(72) Inventor: Michael T. Leis, Santa Clara, CA (US)

(21) Appl. No.: 13/652,178

(22) Filed: Oct. 15, 2012

Related U.S. Application Data
(60) Provisional application No. 61/552,407, filed on Oct. 27, 2011.

(51) Int. Cl. B08B 1/00

(52) U.S. Cl. 15/236.07

(57) ABSTRACT

A grill grate cleaning tool has a handle portion and a metal blade portion secured to the handle portion. The blade portion has a shape that contours to at least a top portion of rods forming the grate. The blade portion has a beveled scraping end that presses against the rod as the blade portion is moved along the rod at an angle. In one embodiment, the blade portion is rounded with straight sides that form a U-shape to enable the tool to be tilted with respect to the rods to clean a portion of an underside of the rods. The blade portion may be pivotable with respect to the handle. The tool allows the user to press down on the rod at a variety of angles to scrape food remnants from the top, sides, and bottom of the rods.

### CROSS-REFERENCE TO RELATED APPLICATIONS

This application claims priority from U.S. provisional application Ser. No. 61/552,407, entitled BBQ Grill Cleaner, filed Oct. 27, 2011, by Michael Leis, incorporated herein by reference.

### FIELD OF THE INVENTION

This invention relates to a tool for cleaning a grate of a barbeque grill.

### BACKGROUND

A barbeque grill typically has a grate that had cylindrical rods connected together by crossbars welded to the rods. After cooking meat, fish, or other foods, there are typically burned remnants of the food that adhere strongly to the rods. Such remnants need to be cleaned off the rods before the next use of the grill.

The most common tool for cleaning the rods is a wire brush. However, the resilience of the wires prevents applying a strong scraping force on the rods. Further, the wires are typically round and do not scrape off all the remnants from the rods.

What is needed is an improved tool for cleaning the grill of a barbeque.

### SUMMARY

A barbecue grate rod cleaning tool is disclosed that has a unique blade design for maximizing leverage, angles, and strength for optimal cleaning of grate rods with minimal effort. Blade components can be made of stainless steel and/or aluminum. In some cases both would be optimal, where a stainless steel blade is first used for removing most of the food remnants, and the softer aluminum blade would be used as a finisher. A stainless steel blade may not be suitable for coated grate rods (enamel, nickel, chrome, etc.) since the scraping of the hard steel blade against the coating may chip the coating.

The handle body can be made using injection molding of a material like Nylon which has high heat tolerance and is structurally strong enough for the intended use.

The blade may be fixed to the handle body, pivotable, or interchangeable.

The blade is contoured to match the particular shape (e.g., circular diameter) of the rod, and a set of interchangeable blades may include a different blade for each standard grate rod shape.

If the rods are cylindrical, the blade has an end with a circular top portion to scrape the top half of the rods, and the sides of the blade are extended to be substantial parallel to each other to form a U-shape. The U-shape also provides strength to the blade. The blade may be first moved along a rod at a, for example, left sideways angle (e.g., about 45 degrees) so that the circular top portion of the blade scrapes the top and part of the left side of the rod, and the extended left side of the blade scrapes a left underside portion of the rod. The blade may then be moved at a right sideways angle to scrape the top and right side of the rod and to allow the extended right side edge to scrape the right underside portion of the rod.

The sides are short enough to not be blocked by the crossbars welded to the bottoms of the rods when the center of the blade is directly over the center of the rod. If the blade is tilted sideways, one side of the blade may contact the crossbars and would have to be lifted or un-tilted as the blade is moved over the crossbars.

The sides of the blade may terminate in wide fins, perpendicular to the sides, to clean the cross-bars as the tool is moved over the rods.

The end of the blade is sharpened to dig under the food remnants and scrape the top half of the rod. Therefore, at least the top half of the rods may be substantially cleaned of food remnants.

For non-cylindrical rods, the blade is formed to contour to the rod. For example, the rods may be trapezoidal shaped with a narrow flat or curved top and sloping out sides. Thus, the blade will have the same shape. Other blade shapes are envisioned for all standard rod shapes.

The metal blade may extend from a much wider portion that is of a size larger than the openings between the rods to prevent the tool from plunging between the rods and to prevent the user's hand from contacting the rods. This wider portion may be part of the handle or part of a shaft extending from the handle that holds the blade.

The shaft or blade is connected a large handle for ease of controlling the blade. The shaft/blade and the handle can be in-line or form an obtuse angle up to and including a 90 degree angle. The angle formed by the handle and shaft/blade makes it easier to apply pressure to the tip of the blade.

Various other embodiments are described.

### BRIEF DESCRIPTION OF THE DRAWINGS

FIG. 1 is a perspective view of one embodiment of the tool having a blade angled with respect to the handle.

FIG. 2 is a side view of the tool of FIG. 1.

FIG. 3 is a bottom view of the tool of FIG. 1.

FIG. 4 is a front view of the tool of FIG. 1.

FIG. 5 is a perspective view of another embodiment of the tool having a blade secured to the sides of the handle.

FIG. 6 is a perspective view of another embodiment of the tool having a collapsible blade for storage and increased safety.

FIG. 7 is a perspective view of another embodiment of the tool having a handle at about 90 degrees with respect to the blade.

FIG. 8 is a perspective view of another embodiment of the tool having an integral blade, shaft, and handle.

FIG. 9 illustrates some of the angles that should be considered when forming the scraping edge of the blade.

FIG. 10 illustrates the same angles as FIG. 9 but the grate rod is a different shape.

FIG. 11 illustrates the same angles as FIG. 9 but the blade body shape and the grate rod profile are of differing shapes.

FIG. 12 illustrates a variety of angles of the blade to the rod during scraping, where the centerline through the blade body is shown as it moves along the grate rod during use. Also shown are some possible angles of rake.

FIG. 13 illustrates cross-sections of different shaped grate rods welded to cross-bars to show various cutting edges and the effects of angling the blade with respect to the rod.

FIG. 14 illustrates more detail of certain scraping angles and measurements for making a blade body with a cutting edge.

FIGS. 15A and 15B are side and front views, respectively, of an embodiment of the blade body formed as single forged piece.

FIGS. 16A, 16B, and 16C are bottom, side, and front views, respectively, of another embodiment of the blade body.

FIGS. 17A, 17B, and 17C are bottom, side, and front views, respectively, of another embodiment of the blade body.

FIGS. 18A, 18B, and 18C are bottom, side, and front views, respectively, of another embodiment of the blade body.

FIG. 19: illustrates a nested set of different sized blade bodies that could be used in a multi-tool version of the present invention.

FIG. 20 is a perspective view of the tool being used to clean a grate rod.

FIG. 21 is a side view of another possible embodiment of the tool.

FIG. 22 is a perspective view of the blade body used in FIG. 21.

FIG. 23 is a perspective view of another possible embodiment of the tool.

FIG. 24 is a perspective view of an embodiment of the tool in which the blade body is separate from the shaft, and the blade body is interchangeable.

FIG. 25 is a side view of the tool of FIG. 24.

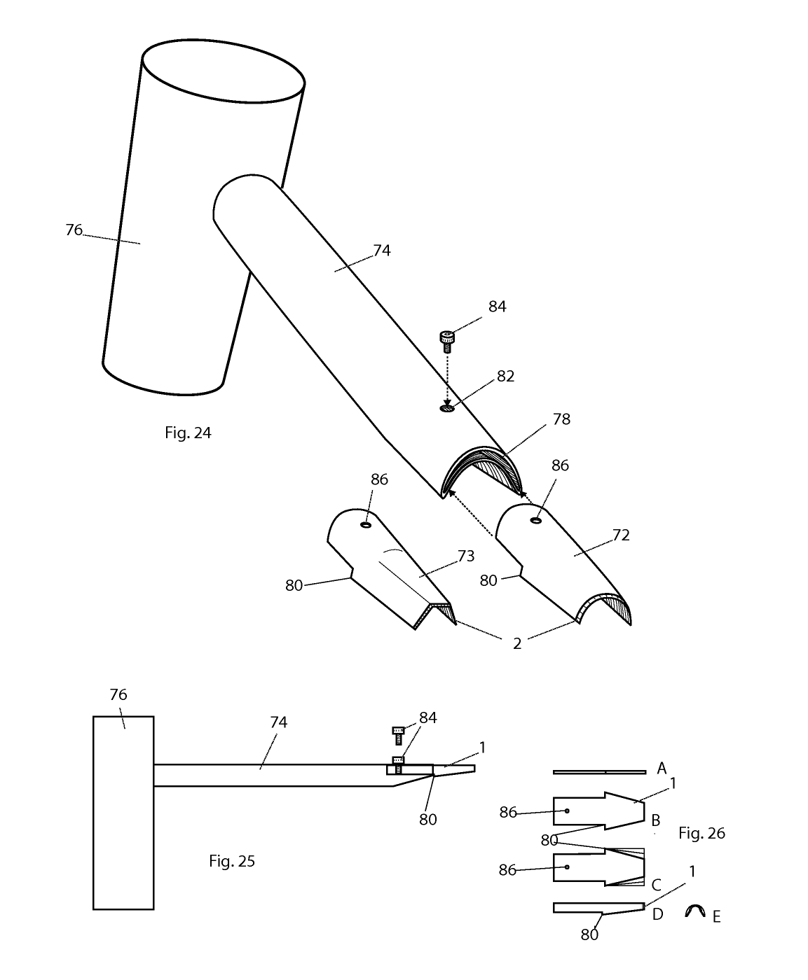

FIG. 26A-26E show various views of the blade body of FIG. 24 including:
A. a flat blade body side view prior to the blade body being pressed into its final shape;
B. a flat top view;
C. a flat top view with different possible sizes of the cutting edge 5;
D. a formed side view, after the blade body has been pressed into shape; and
E. a formed front view.

Elements that are the same or equivalent are labeled with the same numeral.

### DETAILED DESCRIPTION

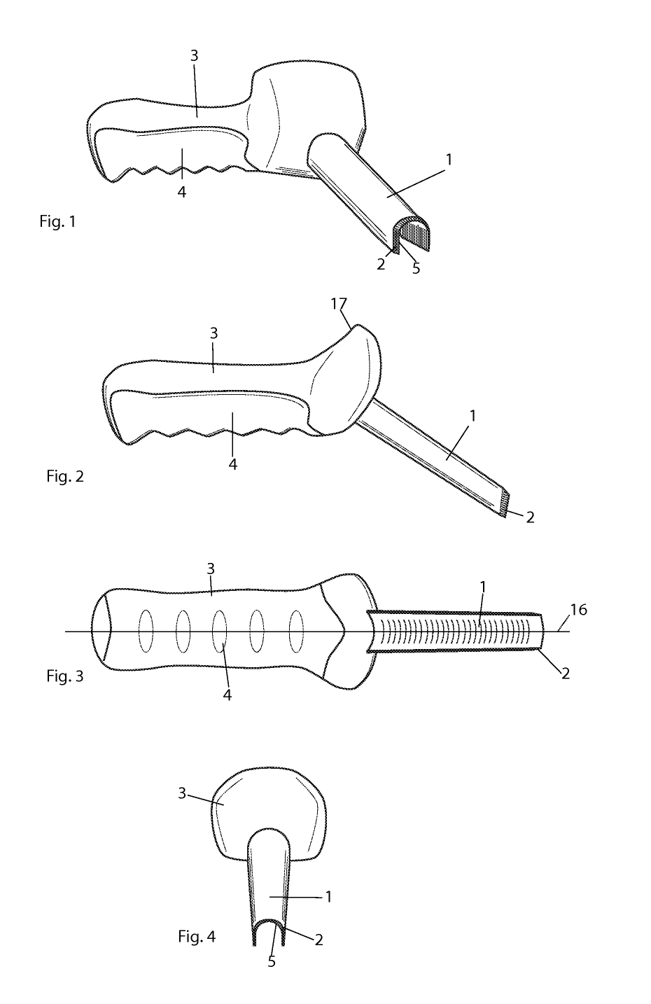

FIG. 1 shows a perspective view of an embodiment of the tool. A blade body 1 has a bevel 2 which forms its cutting edge 5 on the leading edge of the blade body 1. The trailing end of the blade body 1 is fixed to the leading end of the handle body 3 with an ergonomic grip 4. As is visible in the diagram, the handle body 3 and blade body 1 form an obtuse angle which provides better leverage for the operator of the tool. The blade body 1 and handle body 3 may form an angle of up to 90 degrees or may also be in-line.

FIG. 2 shows a side view of this tool. The obtuse angle formed by the blade body 1 and the handle body 3 is illustrated. The length and shape of the blade body 1 can vary for hot or cold grill usage applications. Also note the enlarged leading end of the handle body 3 to prevent the operator's hand from slipping and also allows for a thumb rest 17.

FIG. 3 shows a bottom view of this tool. A centerline 16 shows the path along which alternate locations of the blade body 1 could be fixed to the handle body 3. Also shown is the ergonomic grip 4 which allows for easy handling of the tool. A larger handle body 3 diameter provides stable handling of the tool. Also, the blade body 1 may project outward from the handle body 3 from any point along the centerline 16 of the underside of the handle body 3.

As the fixation point of the blade body 1 to the handle body 3 moves from the leading end toward the trailing end of the handle body 3, the angle formed by these parts would change from obtuse to acute.

FIG. 4 shows a front view of the tool.

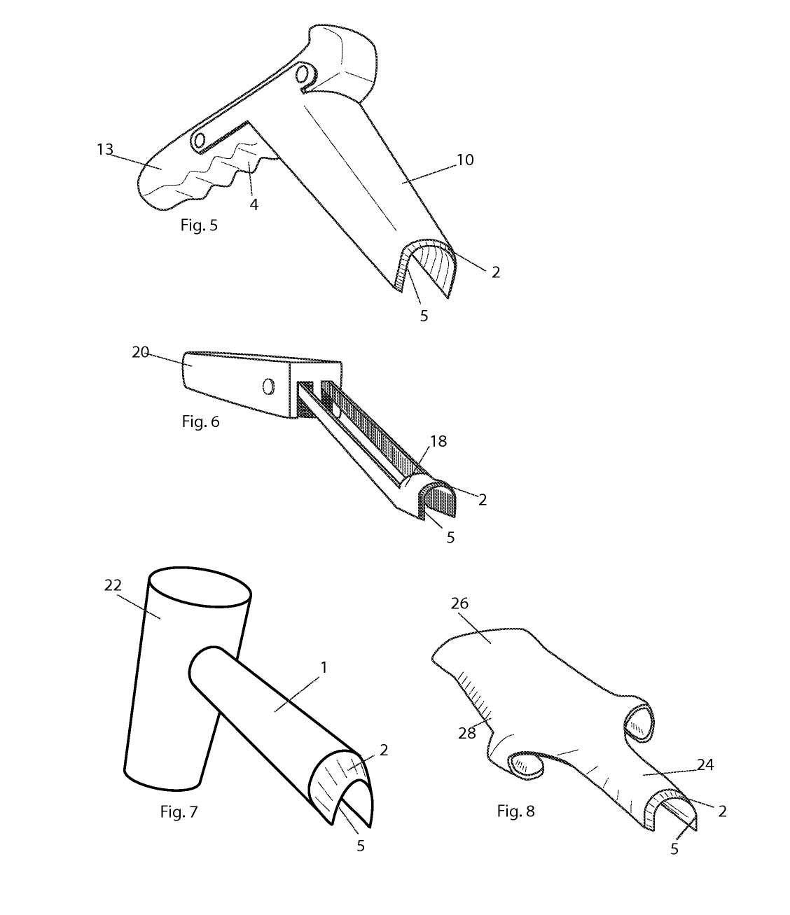

FIG. 5 shows another possible embodiment of this tool where the blade body 10 is connected to the handle 13 with pins, screws, bolts, or other fasteners. The blade body 10 has a bevel 2 that forms the cutting edge 5. The handle body 13 has an ergonomic grip 4.

FIG. 6 shows another possible embodiment of this tool. In this case, the tool can be a multi-tool which could have several fold-out blade bodies, such as blade body 18, to fit different grate rods. The handle 20 has grooves that receive the blade body 18.

FIG. 7 shows another possible embodiment of this tool. In this embodiment the blade body 1 and handle body 22 form a right angle.

FIG. 8 shows another possible embodiment of the tool. This diagram shows a single piece of material, such as stainless steel, that has been formed to make both a blade body 24 and a handle body 26. This diagram also shows the bevel 2 that forms the cutting edge 5 and an ergonomic grip 28.

FIG. 9 shows some of the angles that should be considered when forming the cutting edge 5. The blade body shape 30 can be of any size and shape. The blade body shape 30 here is a half circle, an appropriate shape for a round grate rod 32, in various sizes that contour to the grate rod profile 34. A more preferred blade body shape has parallel extensions to the half circle as shown in FIG. 1. The grate rod profile 34 shape is determined by the intersection of a plane 36 that is perpendicular to the grate rod 32 and projects through the grate rod 32 at some angle, the intersection of the plane 36 and the grate rod 32 determines the grate rod profile 34. The plane 36 can pass through the grate rod 32 at any angle of rake E. Notice how the shape of the grate rod profile 34 changes as the angle of rake E changes.

FIG. 10 shows the same angles as FIG. 9 but in this case the grate rod 38 is a trapezoidal shape. The blade body shape 40 and grate rod profile 42 are shown for different angles.

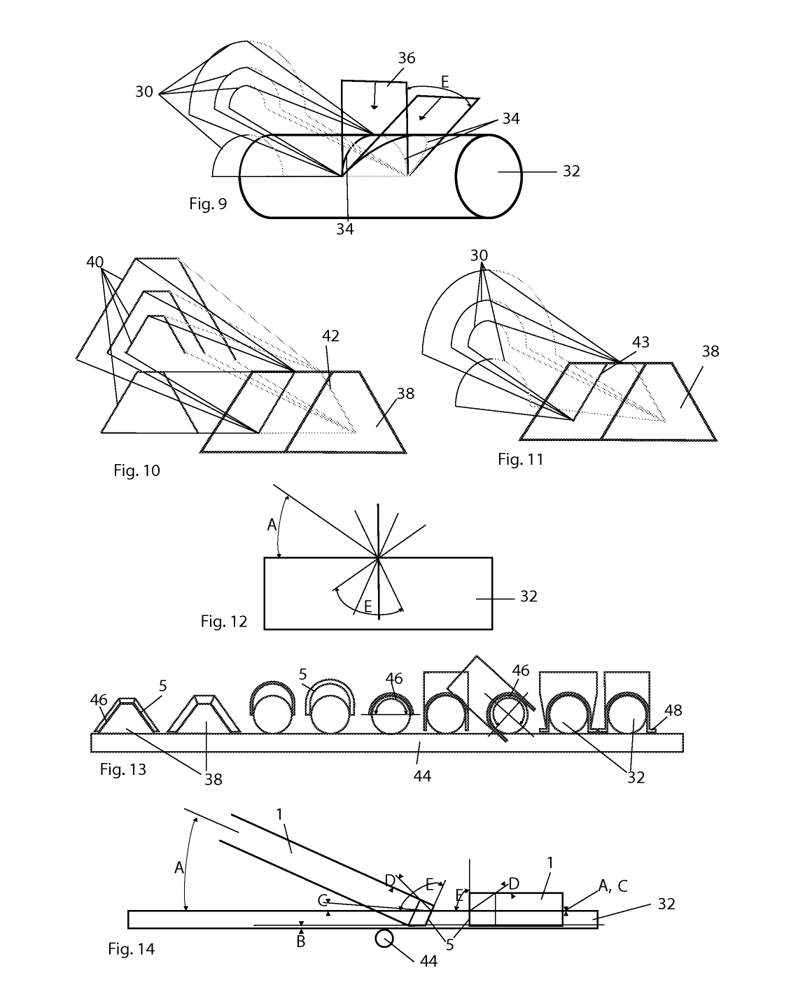

FIG. 11 shows the same angles as FIG. 9 but in this diagram the blade body shape 30 and the grate rod profile 43 are of differing shapes, so poor cleaning results. The blade body shape 30 is not limited to what is shown in these diagrams.

FIG. 12 highlights the angle of attack A, which is the centerline through the blade body as it is presented to the grate rod 32 during use. Also shown are some possible angles of rake E.

FIG. 13 illustrates a grate rod support 44 (a cross-bar) on top of which are the cross-sections of some angular grate rods 38 and some round grate rods 32. The purpose of this diagram is to show some other aspects of the design of the blade body and cutting edge 5. Note the different thickness of materials. Of importance here is the blade contact area 46 which is how much of the grate rod 32/38 the cutting edge 5 can make contact with during use. With round grate rods 32, the cutting edge 5 can rotate around the grate rod 32 to maximize the surface area of the grate rod 32 that can be cleaned.

Another possible feature of the cutting edge 5 could be the addition of cross-member cleaning fins 48, whose widths would be half of the space between grate rods 32 (much wider than shown). The cross-member cleaning fins 48 would remove the debris built up on the top surface of the grate rod supports 44 as the blade body moves along the rods 32.

The available blade shapes would match standard rod shapes.

FIG. 14 illustrates more of the important angles and measurements for making a blade body 1 with a cutting edge 5. Shown is a grate rod support 44 with a grate rod 32, on top of which are two blade bodies 1. Angle A is the angle of attack, described in FIG. 12. The measurement B is the clearance of the blade body 1 and cutting edge 5 over the grate rod support 44. Angle C is the clearance between the blade body 1 and the grate rod 32. Angle D is the angle of the bevel 2. Angle E is the angle of rake E.

FIGS. 15A and 15B show a side and front view of another embodiment of the blade body 50 being a single forged piece. The blade body 50 is then secured to a handle, or the blade body 50 can be formed to end in a handle.

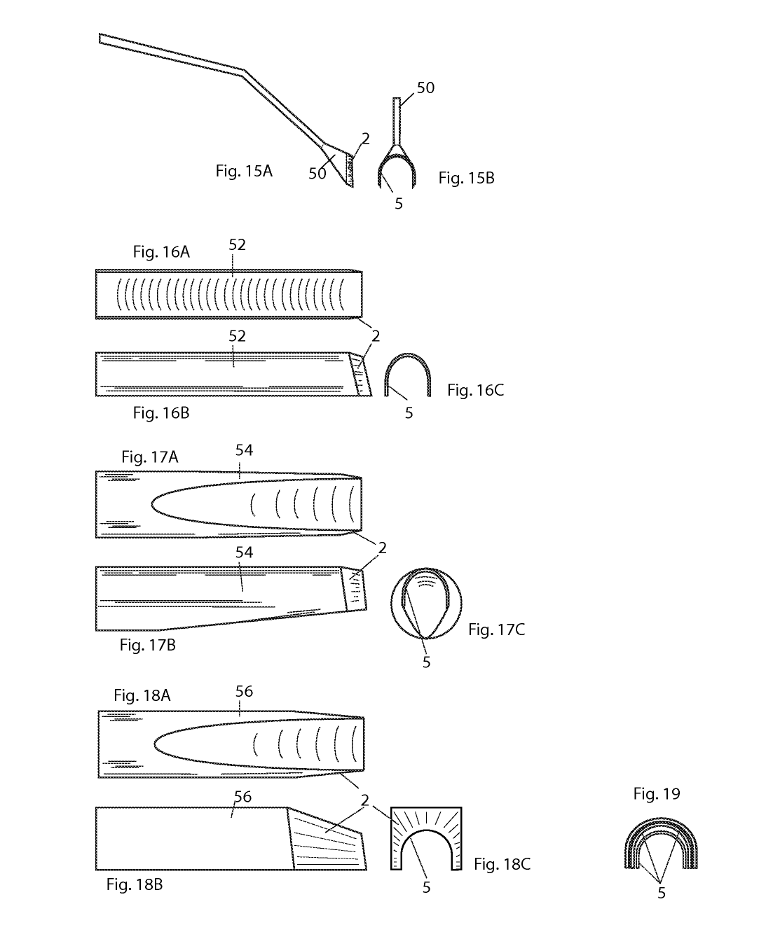

FIGS. 16A, 16B, and 16C show a bottom, side, and front view of another embodiment of the blade body 52. This may be an extrusion or stamped sheet product.

FIGS. 17A, 17B, and 17C show a bottom, side, and front view of another embodiment of the blade body 54. This version may be solid stock (cast/machined/etc.) or tubing stamped to form the cutting edge 5.

FIGS. 18A, 18B, and 18C show a bottom, side, and front view of another embodiment of the blade body 56. This version may be solid stock (cast/machined/etc.).

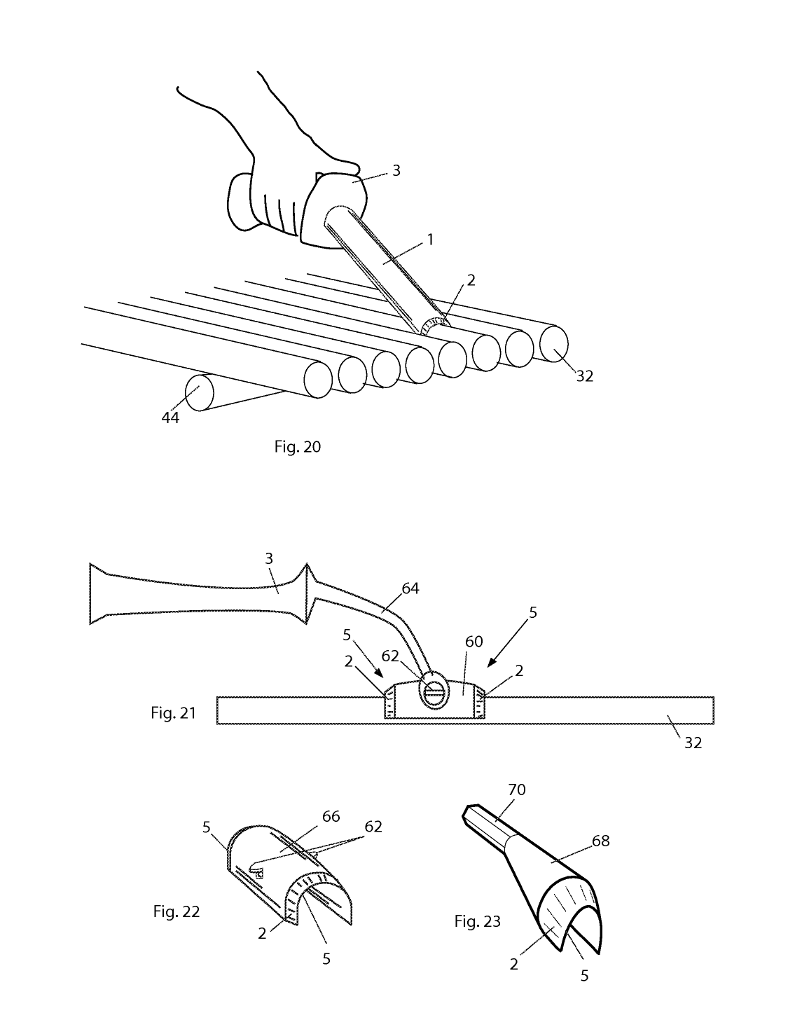

FIG. 19 shows a nested set of different sized blade bodies (looking straight at their different cutting edges 5) that could be used in a compact, collapsible, multi-tool version of the present invention similar to FIG. 6.

FIG. 20 shows a perspective view of the tool of FIG. 1 being used to clean a grate rod 32.

FIG. 21 shows another possible embodiment of the tool. In this case, the blade body 60 has two cutting edges 5 to make a dual action tool, where the tool cleans the grate rod 32 in both directions. This design uses the same cutting edge 5 as the previous embodiments but the mount has a pivot point 62 to allow the cutting edges 5 to rotate and self-position themselves on the grate rod 32. This design also has a shank 64 to connect the blade body 60 to the handle body 3.

FIG. 22 shows a perspective view of the blade body 60 used in FIG. 21. The key features are the bevels 2 to create the cutting edges 5. Also shown are the pivot points 62 which can be holes, tabs, etc.

FIG. 23 shows another possible embodiment of the tool. This is a hex bit version of the blade body 68. This tool would fit into existing hex drivers via the hex bit shank 70 to be made in various sizes and shapes.

FIG. 24 shows a perspective view of an embodiment of the tool in which the blade body 72 is separate from the shaft 74, and the blade body 72 is interchangeable. A second blade body 73 is shown. Here the handle body 76 and the shaft 74 form a 90 degree angle, with the shaft 74 extending from the handle body 76 approximately a third of the way from the top, the handle body 76 being long enough to place the entire hand below the shaft 74 or with two fingers place over the shaft 74. The shaft 74 in this preferred embodiment is a tube of stainless steel, in which the distal end of the shaft 74 has been pressed in on itself at an angle to create a curve that tapers from approximately 1.5 inches in from the distal end of the shaft 74 to the end of the shaft 74 to form a crescent shaped opening 78 into which the blade body 72 is inserted. The crescent shaped opening 78 will be the standard shape for the proximal end of the blade body 72 where the cutting edge 5 can be shaped to fit any shape of grate rod (e.g., rods 32 and 38 in FIG. 13). The blade body 72 has stops 80 which keep the blade body 72 from being inserted too far. A hole 82 in the shaft allows for a screw 84 to be inserted into a threaded hole 86 in the blade body 72/73 to hold the blade body 72/73 firmly in place. Other methods of holding the blade body 72/73 in place are also available such as a magnet, spring clips, etc.

A plurality of identical replaceable blade bodies 72/73 may be supplied for replacement when one gets dulled.

FIG. 25 shows a side view of the tool of FIG. 24 to show how the elements fit together.

FIG. 26A-26E show various views of the blade body 72 of FIG. 24 including:
A. a flat blade body side view prior to the blade body being pressed into its final shape;
B. a flat top view;
C. a flat top view with different possible sizes of the cutting edge 5;
D. a formed side view, after the blade body has been pressed into shape; and
E. a formed front view.

Other embodiments are envisioned.

While particular embodiments of the present invention have been shown and described, it will be obvious to those skilled in the art that changes and modifications may be made without departing from this invention in its broader aspects and, therefore, the appended claims are to encompass within their scope all such changes and modifications that are within the true spirit and scope of this invention.

What is claimed is:

1. A grill grate cleaning tool comprising:
a handle portion; and
a rigid blade portion secured to the handle portion, the blade portion having a shape that contours to at least a top portion of rods forming the grate, the blade portion having a scraping end that presses against each rod as the blade portion is moved along the rod.

2. The tool of claim 1 wherein the handle portion and blade portion are integral.

3. The tool of claim 1 wherein the handle portion and the blade portion are separate pieces secured together.

4. The tool of claim 1 wherein the shape of the blade portion is rounded to substantially conform to cylindrical rods forming the grate.

5. The tool of claim 4 wherein the blade portion is rounded with straight sides that form a U-shape to enable the tool to be tilted with respect to the rods to clean a portion of an underside of the rods.

6. The tool of claim 1 wherein the handle portion forms an angle greater than 90 degrees with respect to the blade portion.

7. The tool of claim 1 wherein the handle portion forms an angle of approximately 90 degrees with respect to the blade portion.

8. The tool of claim 1 wherein the scraping end is a beveled end of the blade portion.

9. The tool of claim 1 wherein the blade portion is pivotable with respect to the handle portion.

10. The tool of claim 9 wherein the blade portion collapses such that the blade portion is at least partially within the handle portion when collapsed.

11. The tool of claim 1 further comprising a shaft between the blade portion and the handle portion.

12. The tool of claim 1 wherein the blade portion extends to the handle portion.

13. The tool of claim 1 wherein the blade portion comprises stainless steel.

14. The tool of claim 1 further comprising a shaft between the blade portion and the handle portion, wherein the blade portion is pivotable around an end of the shaft such that an angle of the blade portion when scraping the rod is independent of an angle of the handle portion.

15. The tool of claim 1 further comprising a shaft between the blade portion and the handle portion, wherein the blade portion is releasably connected to the shaft, the tool further comprising multiple blade portions that are attachable to the shaft.

16. The tool of claim 1 wherein the multiple blade portions comprise blade portions having different shapes for different rods.

17. The tool of claim 1 wherein the blade portion has angled scraping edges to substantially conform to trapezoidal shaped rods forming the grate.

18. The tool of claim 1 wherein the blade portion is formed to fit over standard size rods forming grates.

19. The tool of claim 1 wherein the blade portion has first scraping edges that scrap the rod, the first scraping edges terminating in rigid fins for cleaning cross-bars supporting the rods as the blade portion is moved over the rod.

20. The tool of claim 1 wherein the fins have a width substantially one half a width of the distance from rod to rod.
